(19) United States
(12) Patent Application Publication
(10) Pub. No.: US 2021/0324984 A1
(43) Pub. Date: Oct. 21, 2021

(54) ELECTROSTATIC DISCHARGE MITIGATION DEVICE

(71) Applicant: ENTEGRIS, INC., Billerica, MA (US)

(72) Inventors: Jeffrey J. Mckenzie, Watertown, MN (US); Jeffrey Kubesh, Jordan, MN (US); John A. Leys, Chaska, MN (US); James C. Linder, Victoria, MN (US)

(21) Appl. No.: 17/232,489

(22) Filed: Apr. 16, 2021

Related U.S. Application Data
(60) Provisional application No. 63/011,809, filed on Apr. 17, 2020.

(51) Int. Cl. F16L 25/01; H01R 4/50; H01R 4/60; H01R 4/64; F16L 9/12

(52) U.S. Cl. CPC F16L 25/01; H01R 4/5091; H01R 4/5083; H01B 1/24; H01R 4/64; F16L 9/125; H01R 4/60

(57) ABSTRACT

This disclosure provides electrostatic discharge mitigation devices. In one or more embodiments, the electrostatic discharge mitigation device is an electrically conductive insert to transfer static charge from electrically conductive polymer tubing to an electrically conductive polymer operative component.

### CROSS REFERENCE TO RELATED APPLICATION

This application claims the benefit of and priority to U.S. Provisional Application No. 63/011,809 filed on Apr. 17, 2020, which is incorporated herein by reference in its entirety for all purposes.

### TECHNICAL FIELD

This disclosure relates to electrostatic discharge (ESD) mitigation devices that may be used, for example, in fluid handling systems, and more specifically, for use in ultra-pure fluid handling systems benefitting from electrostatic discharge mitigation.

### BACKGROUND

Electrostatic discharge (ESD) is an important technical issue for fluid handling systems in the semiconductor industry and in other technology applications. Frictional contact between fluids and surfaces of various operational components (e.g. tubing or piping, valves, fittings, filters, etc.) in the fluid system can result in generation and buildup of static electrical charges. The extent of charge generation depends on various factors including, but not limited to, the nature of the components and the fluid, fluid velocity, fluid viscosity, electrical conductivity of the fluid, pathways to ground, turbulence and shear in liquids, presence of air in the fluid, and surface area. These properties, and ways to mitigate the undesired static electrical charge caused by these properties, are discussed, and reported in NFPA 77, “Recommended Practice on Static Electricity,” pp. 77-1 to 77-67, 2014.

Further, as the fluid flows through the system, the charge can be carried downstream in a phenomenon called a streaming charge, where charge may buildup beyond where the charge originated. Sufficient charge accumulations can cause ESD at the tubing or pipe walls, component surfaces, or even onto substrates or wafers at various process steps.

In some applications, semiconductor substrates or wafers are highly sensitive to static electrical charges and such ESD can result in damage or destruction of the substrate or wafer. For example, circuits on the substrate can be destroyed and photoactive compounds can be activated prior to regular exposure due to uncontrolled ESD. Additionally, built up static charge can discharge from within the fluid handling system to the exterior environment, potentially damaging components in the fluid handling system (e.g. tubing or piping, fittings, components, containers, filters, etc.), that may lead to leaks, spills of fluid in the system, and diminished performance of components. In these situations, such discharge, may lead to potential fire or explosion when flammable, toxic and/or corrosive fluids are used in the compromised fluid handling system.

Often the weak link in an electrical system is the integrity of the ground. In some fluid handling systems, to reduce the buildup of static charges, certain metal or conductive components in fluid handling system are grounded to mitigate the buildup of static charge in the system as it continually disperses from the metal or conductive components to ground. In some systems, a conductive cable tie or “zip-tie” composed of a conductive polymer is sometimes used for connecting components to ground. Such polymeric cable ties are prone to creep, movement, breakage, environmental effects or sensitivity, deterioration, wear, etc., and have many drawbacks in practice.

It would be desirable to improve ESD mitigation and grounding devices for use in ultra-pure fluid handling systems that gives improved component reliability, stability, performance, and reduction in potentially damaging ESD events.

### SUMMARY OF THE INVENTION

One or more embodiments of this disclosure are related to electrostatic discharge (ESD) mitigation devices. In particular, embodiments are directed to an electrostatic discharge mitigation device comprising an electrically conductive insert to transfer static charge from electrically conductive polymer tubing to an electrically conductive polymer operative component to facilitate grounding of a fluid circuit.

Some embodiments of this disclosure comprise a tubing connector to connect two or more electrically conductive tubing segments in a fluid circuit, the tubing connector comprising an electrically conductive polymer connector body with two or more attachment portions, two or more attachment fittings, an electrically conductive polymer insert electrically contacting the electrically conductive connector body, and an electrically conductive bracket configured to attach and interface with the connector body to electrically connect the connector body to ground.

In various embodiments of the tubing connector, the tubing connector includes a straight connector, a T-connector, or an elbow connector. In certain embodiments of the tubing connector, the tubing connector is a straight connector having a fluid passageway to connect two tubing segments. In certain embodiments of the tubing connector, the tubing connector is an elbow connector having a fluid passageway to connect two tubing segments. In certain embodiments of the tubing connector, the tubing connector is a T-connector having fluid passageways to connect three tubing segments. In certain embodiments of the tubing connector, the connector body attachment portions include a threaded region and a nipple region to receive a tubing segment. In certain embodiments of the tubing connector, the attachment fittings include compression nuts to attach tubing segments to the threaded and nipple regions of the tubing connector.

In some embodiments of this disclosure comprise a fluid circuit for a predetermined fluid flow passageway having at least one inlet and at least one outlet, the fluid circuit including:
a. a plurality of electrically conductive polymer tubing segments;
b. a plurality of electrically conductive polymer tubing connectors, each tubing connector comprising a connector body with an internal fluid flow passageway and a plurality of tubing connector fittings and electrically conductive inserts, the tubing connectors connecting the plurality of tubing segments at selected tubing connector fittings and electrically conductive inserts, the plurality of tubing segments and tubing connectors providing the fluid flow passageway through the fluid circuit; and
c. at least one electrically conductive bracket configured to hold and interface with the connector body to electrically connect the tubing connector to ground.

Another embodiment of this disclosure is an electrostatic discharge mitigation fluid pathway comprising an electrically conductive polymer insert to transfer static charge from electrically conductive polymer tubing to an electrically conductive polymer operative component.

Still another embodiment of this disclosure is an electrically conductive fluid circuit comprising electrically conductive polymer tubing, an electrically conductive polymer operative component, an electrically conductive polymer insert, and an electrically conductive bracket dissipating static charge to ground.

This disclosure further describes an embodiment of a method of making an electrostatic discharge mitigation fluid pathway having at least one inlet and at least one outlet including: a) connecting a plurality of electrically conductive polymer tubing segments to a plurality of operative components, each operative component comprising an electrically conductive polymer body portion with an internal fluid flow passageway and a plurality of tubing connector fittings and electrically conductive polymer inserts, the operative components connecting the plurality of electrically conductive tubing segments at selected tubing connector fittings, the plurality of tubing segments and operative components providing the fluid flow passageway through the fluid circuit; wherein each electrically conductive insert and electrically conductive body portion comprises an electrically conductive fluoropolymer, and wherein each of the tubing connector fittings electrically conductively connects the respective conductor of the body portion to the electrically conductive insert; and b) connecting the electrostatic discharge mitigation fluid circuit to ground.

The above summary is not intended to describe each illustrated embodiment or every implementation of the present disclosure.

### BRIEF DESCRIPTION OF THE DRAWINGS

The drawings included in this disclosure illustrate embodiments of the present disclosure and, along with the description, serve to explain the principles of the disclosure. The drawings are only illustrative of certain embodiments and do not limit the disclosure.

FIG. 1 is an isometric view of an electrically conductive insert according to various embodiments of this disclosure.

FIG. 2 is a side view of an electrically conductive insert according to various embodiments of this disclosure.

FIG. 3a is a cross-sectional view of an electrically conductive connector with an electrically conductive tubing and an electrically conductive insert according to various embodiments of this disclosure.

FIG. 3b is a cross-sectional view of an electrically conductive connector with an electrically conductive tubing and an electrically conductive insert according to various embodiments of this disclosure.

FIG. 4 is a partial cross-sectional view of an electrically conductive connector with an electrically conductive tubing and an electrically conductive insert according to various embodiments of this disclosure.

FIG. 5 is an isometric view of an ESD mitigation tubing connector having an electrically conductive insert (not shown) and a conductive bracket for grounding a polymeric conductive body, according to various embodiments of this disclosure.

FIG. 6 is an exploded view of the alternative ESD mitigation tubing connector of FIG. 4, according to various embodiments of this disclosure.

FIG. 7 is a digital image of different ESD mitigation tubing connectors and electrically conductive tubing that may be used with an electrically conductive insert of various embodiments of this disclosure.

FIG. 8 is an alternative ESD mitigation tubing connector that may be used with an electrically conductive insert of various embodiments of this disclosure according to various embodiments.

FIG. 9 is another alternative ESD mitigation tubing connector that may be used with an electrically conductive insert of various embodiments of this disclosure, according to various embodiments.

FIG. 10 is another alternative ESD mitigation device that may be used with an electrically conductive insert of various embodiments of this disclosure.

FIG. 11 is a fluid handling system that may be used with an electrically conductive insert of various embodiments of this disclosure.

The embodiments of this disclosure are amenable to various modifications and alternative forms, and certain specifics have been shown, for example, in the drawings and will be described in detail. It is understood that the intention is not to limit the disclosure to the particular embodiments described; the intention is to cover all modifications, equivalents, and alternatives falling within the spirit and scope of this disclosure.

### DETAILED DESCRIPTION

The following detailed description should be read with reference to the drawings in which similar elements in different drawings are numbered the same. The detailed description and the drawings, which are not necessarily to scale, depict illustrative embodiments and are not intended to limit the scope of the invention. The illustrative embodiments depicted are intended only as exemplary. Selected features of any illustrative embodiment may be incorporated into an additional embodiment unless clearly stated to the contrary.

This disclosure reports embodiments of electrostatic discharge (ESD) mitigation devices for use with a fluid handling system having a fluid flow passageway from a fluid supply to one or more downstream process stages. Embodiments of this system include a fluid circuit including conductively connected operative components and ESD mitigation tubing segments. Conventional and some ESD mitigation fluid circuits are reported, for example, in International patent application, WO 2017/210293, which is incorporated herein by reference, except for express definitions or patent claims contained therein. Other ESD mitigation fluid circuits are reported, for example, in an Entegris brochure, FLUOROLINE Electrostatic (ESD) Tubing, 2015-2017. Other U.S. patent applications owned by Applicant, U.S. patent application Ser. No. 16/287,847 filed Feb. 27, 2019 and U.S. Provisional Patent Application No. 62/851,667,783, filed May 23, 2019, are both hereby incorporated by reference for all purposes.

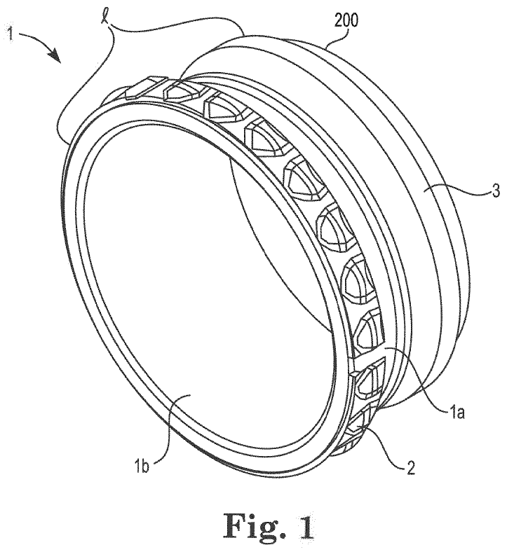

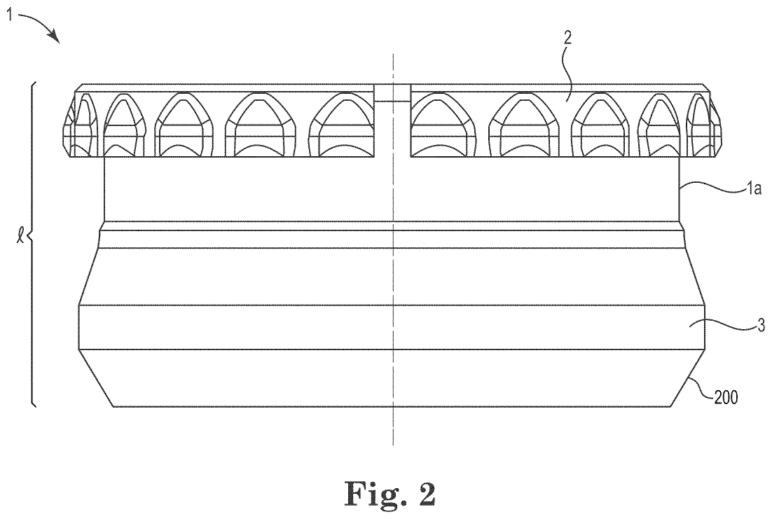

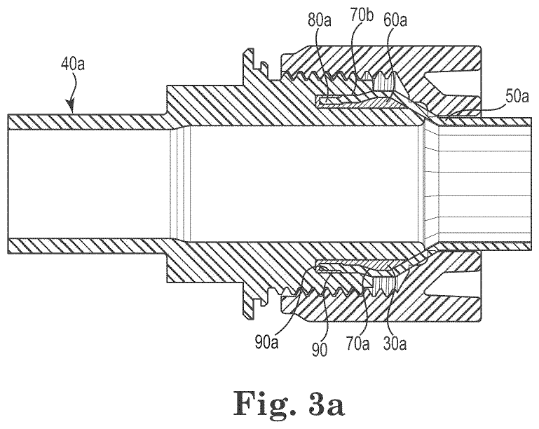

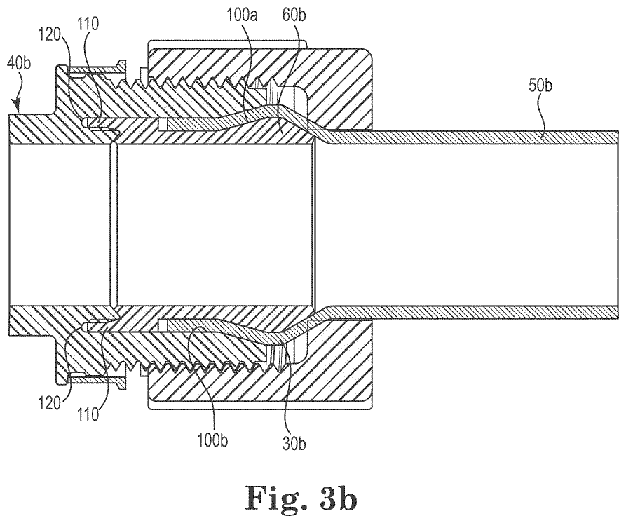

FIG. 1 illustrates one embodiment of an electrically conductive insert 1 of this disclosure. FIG. 2 is a side view of the electrically conductive insert 1 illustrated in FIG. 1. The electrically conductive insert is formed from a collar 200 of an electrically conductive material. The collar 200 forming the conductive insert 1 has a length l, an inner surface 1b defining an inner diameter, and an outer surface 1a defining an outer diameter such that the collar 200 can be coupled to a conductive tubing segment and then also coupled to a conductive operative component to make an electrical connection there between such that an electrical charge can be transferred from the tubing segment to the electrically conductive component and ultimately to ground. The collar 200 can have any suitable length so as to enable the electrically conductive insert to be securely connected to both an electrically conductive tubing segment and an electrically conductive operative component. The outer diameter of the collar 200 forming the electrically conductive insert 1 is sized such that a first portion of the conductive insert 1 friction fits in the inside of an electrically conductive tubing and a second portion of the conductive insert 1 interfaces with a conductive operative component providing a leak proof connection when used to connect the electrically conductive tubing segment to the electrically conductive operative component. In some cases, as depicted in the illustrative embodiment of FIG. 1, the outer surface 1a of the collar forming the electrically conductive insert 1 can include a plurality of raised ribs 2 uniformly distributed about an outer circumference of the collar 200 forming the conductive insert 1. The ribs 2 provide concentrated contact points when at least a portion of the electrically conductive insert is received within the conductive operative component. Additionally, as shown in FIG. 1, the electrically conductive insert 1 includes a ridge 3 circumscribing the outer surface 1a of the collar 200 having an outer diameter that is greater than the inner diameter of the conductive tubing to which it is connected. Such a ridge 3 helps to facilitate a secure friction fit between the electrically conductive insert 1 and the tubing such as tubing 50a and 50b shown in FIGS. 3a and 3b, respectively. The inner surface 1b defines an inner diameter of the conductive insert 1 sized to engage to the connective portion of the conductive operative component. This connective portion also provides a frictional fit that is leak proof when used to connect the conductive tubing to the conductive operable component.

FIG. 3a is a cross-sectional view of an electrically conductive connector 40a coupled with an electrically conductive tubing segment 50a and an electrically conductive insert 60a. Electrically conductive insert 60a has many of the same features as electrically conductive insert 1 shown in FIGS. 1 and 2, described herein. FIG. 3a illustrates the desired friction fit of the conductive tubing segment 50a with a ridge 30a provided on the outer surface 70a of conductive insert 60a and the desired friction fit of the inner surface 70b of the conductive insert with the connection portion of the conductive operate component. Additionally, in some embodiments as shown in FIG. 3a, the electrically conductive insert 60a can include a lip 90 defining a space between an inner surface 90a of the lip 90 and outer surface 70a of the electrically conductive insert 60a sized to receive and retain an end 80a of the conductive tubing segment 50a to which the conductive insert 60a is coupled.

FIG. 3b is a cross-sectional view of an electrically conductive connector 40b coupled with an electrically conductive tubing segment 50b and an electrically conductive insert 60b. Electrically conductive insert 60b has many of the same features as electrically conductive insert 1 shown in FIGS. 1 and 2, described herein, including ridge 30b. FIG. 3b illustrates the desired friction fit of the conductive tubing segment 50b with the outer surface 100a of conductive insert 60b which is facilitated by ridge 30b and the desired friction fit of the inner surface 100b of the conductive insert 60b with the connection portion of the conductive operative component 40b. In this illustrated embodiment, the inner diameter of the conductive tubing 50b and the inner diameter of the conductive insert 60b are approximately the same diameter. In addition, a distal end 110 of the electrically conductive insert 60b is sized and shaped such that a first leading edge 110a can be received within a recess 120 of the electrically conductive connector 40b and a second leading end 110b abuts an proximal end 122 of the connecter 40b forming a tongue-in-groove seal.

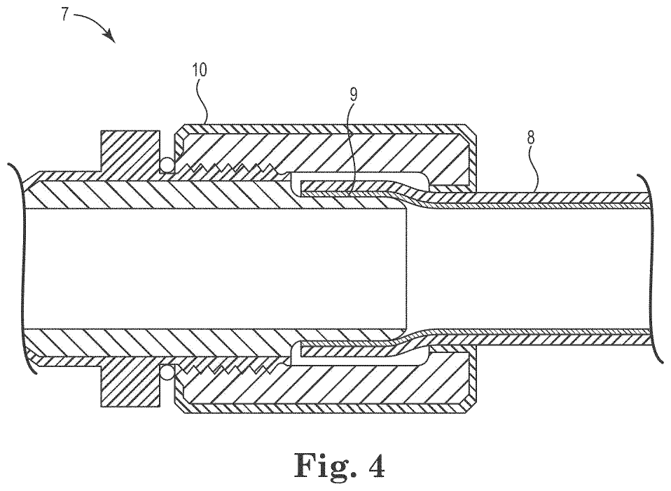

FIG. 4 is a partial cross-sectional view of another embodiment electrically conductive connector 7 with an electrically conductive tubing 8 and an electrically conductive insert 9. FIG. 4 further illustrates the system that includes the connecting nut 10 which provides the desired secure leak proof connection of the conductive tubing to the conductive insert and to the conductive connector according to various embodiments of this disclosure.

Materials used to make the conductive inserts as described herein according the various embodiments are substantially inert to solvents, acid solutions, base solutions, or mixtures thereof. Such solvents include but are not limited to, cyclohexanone, isopropyl alcohol, propylene glycolmonomethyl ether, propylene glycol monomethyl ether acetate, n-butanol, octane, acetone, heptane, hexane, or mixtures thereof. A variety of materials may be used to make the conductive insert including both intrinsically conductive polymers, conductive-filled polymers, and metallic materials. Exemplary conductive-filled polymers include conductive-filled fluoropolymers including perfluoroalkoxy alkane (PFA) and polychlorotrifluoroethylene (PCTFE). The fluoropolymers can be filled with carbon fiber, nickel coated graphite, carbon powder, carbon nanotubes, graphene, or mixtures thereof. In some cases, the PFA can be filled with, metal particles or steel fiber in addition to or instead of a carbon material. In one embodiment, the electrically conductive insert 1 is fabricated from PFA filled with carbon fiber.

Suitable conductive metallic materials include, for example, stainless steel, titanium, nickel, or alloys thereof, or mixtures thereof. Exemplary commercially available metallic materials include, for example HASTELLOY®, INCONEL®, or MONEL®. HASTELLOY® is used to refer to various nickel-molybdenum alloys INCONEL® is used to refer to a family of austenitic nickel-chromium-based superalloys. MONEL® refers to a group of nickel alloys, primarily composed of nickel and copper, with small amounts of iron, manganese, carbon, and silicon.

Those skilled in the art would readily appreciate the variety of manufacturing process that are available to make the conductive insert including, but limited to, molding, casting, or machining processes.

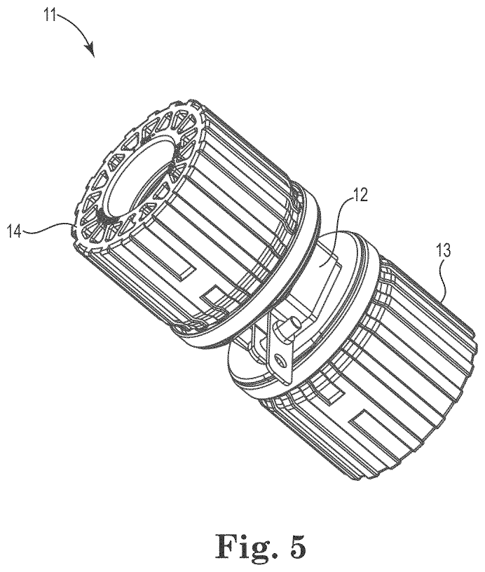

FIG. 5 is an isometric view of an ESD mitigation tubing connector 11 having an electrically conductive insert (not shown) and a conductive bracket 12 for grounding a polymeric conductive connector. The conductive bracket 12 in this figure is a substantially polygonal (e.g., multi-faceted) conductive bracket. Conductive bracket 12 can also represent at least a portion of an ESD grounding strap. FIG. 5 also illustrates a first compression nut 13 that is a circular compression nut. The first compression nut 13 in this embodiment can be similar and/or a mirror image of the second compression nut 14, as shown. Compression nuts 13, 14 can include a female threaded interior portion that is configured to threadably interface with male threads (not shown) in various embodiments.

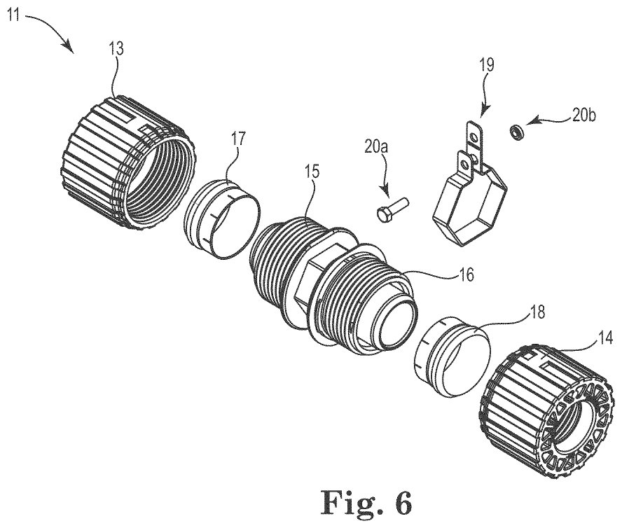

FIG. 6 is an exploded view of the alternative embodiment of an ESD mitigation tubing connector 11 of FIG. 5. FIG. 6 illustrates a first compression nut 13 is a circular compression nut or an attachment threaded connector fitting. The first compression nut 13 in this embodiment can be similar and/or a mirror image of the second compression nut 14, as shown. Compression nuts 13, 14 can each include a female threaded interior portion that is configured to threadably interface with male threads 15, 16 in various embodiments. FIG. 6 also illustrates that the first and second compression nuts or attachment threaded connectors fitting 13, 14 include one or more hollow sections that include “coring.” Coring of various components in various embodiments can have benefits, in particular in larger scale embodiments, and can improve molding characteristics and/or include materials savings, and the like. FIG. 6 further illustrates conductive inserts 17, 18 as well as conductive grounding bracket 19 and grounding bolt and nut 20a, 20b. The conductive bracket 19 includes a clamp portion that interfaces with the connector body and selectively tightens to attach the bracket to the connector body.

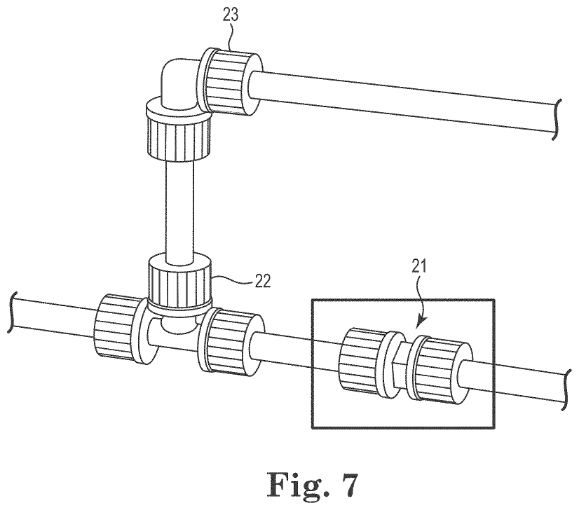

FIG. 7 is a digital image of different ESD mitigation tubing connectors and electrically conductive tubing that may be used with an electrically conductive insert as illustrated in FIG. 6 and various embodiments of this disclosure. This digital image illustrates three types of alternative connectors; a straight connector 21, a t-shaped connector 22 and an elbow connector 23. FIG. 7 represents just three possible connector example shapes and types, although many other variations are also contemplated in this disclosure.

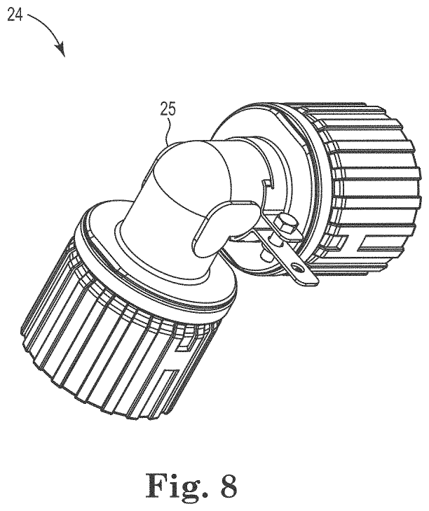

FIG. 8 is an alternative ESD mitigation tubing connector that may be used with an electrically conductive insert as illustrated in FIG. 6 and various embodiments of this disclosure. As shown in FIG. 8, the tubing connector is an elbow-shaped connector 24 having a fluid passageway to connect two tubing segments (not shown). The tubing connector 24 is similar in configuration and function to the straight tubing connector, but the polymeric connector conductive body has a bend at a certain angle, such as 90°, as shown. As shown, one or more gate pad 25 is included on the polymeric connector conductive body. The gate pad 25 can be used for trimming a sprue off various molded parts. Trimming can be accomplished by a free hand knife cut, by machine, or any other suitable techniques.

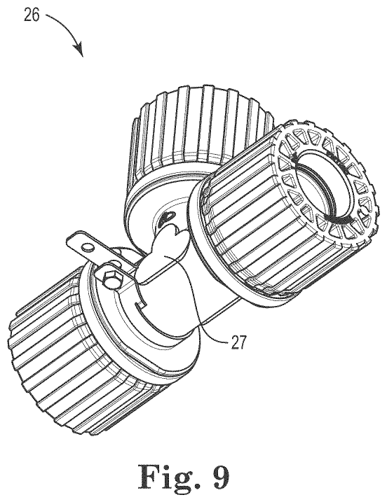

FIG. 9 is another alternative ESD mitigation tubing connector that may be used with an electrically conductive insert as illustrated in FIG. 6 and various embodiments of this disclosure. As shown in FIG. 9, the tubing connector is a T-shaped connector 26 having a fluid passageway to connect three tubing segments (not shown). The tubing connector is similar in configuration and function to the tubing straight and elbow connectors, but the polymeric connector conductive body has a T-shaped, three-way connector with an internal intersection, as shown. A third attachment portion includes third attachment threaded connector. As shown, one or more gate pad 27 is included on the polymeric connector conductive body. The gate pad 27 can be used for trimming a sprue off various molded parts. Trimming can be accomplished by a free hand knife cut, by machine, or any other suitable techniques.

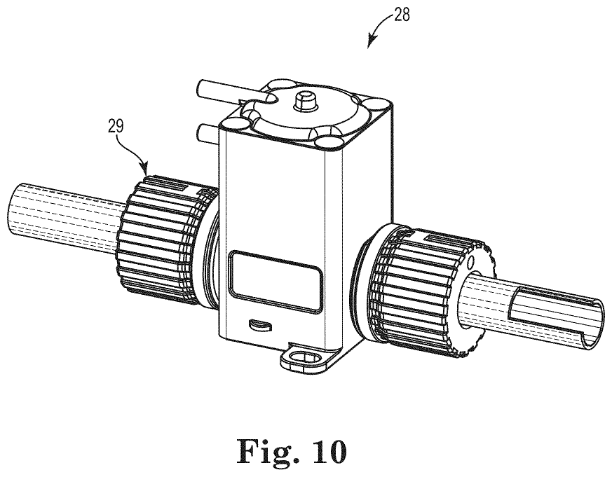

FIG. 10 is another alternative ESD mitigation device that may be used with an electrically conductive insert as illustrated in FIG. 6 and various embodiments of this disclosure. FIG. 10 depicts a valve 28. The valve 28 includes a conductive body portion and two connector fittings extending outwardly from the body portion. In certain embodiments the exterior surface of the compression nuts or attachment connector fittings includes a structure surface 29.

Several types of connector fittings are contemplated herein, made from various polymers, are available and are known, such as PRIMELOCK® fittings, PILLAR® fittings, FLARETK® fittings, flared fittings, and other fittings. Exemplary fittings, for example, are illustrated in U.S. Pat. Nos. 5,154,453; 6,409,222; 6,412,832; 6,601,879; 6,758,104; and 6,776,440; which are hereby incorporated by reference.

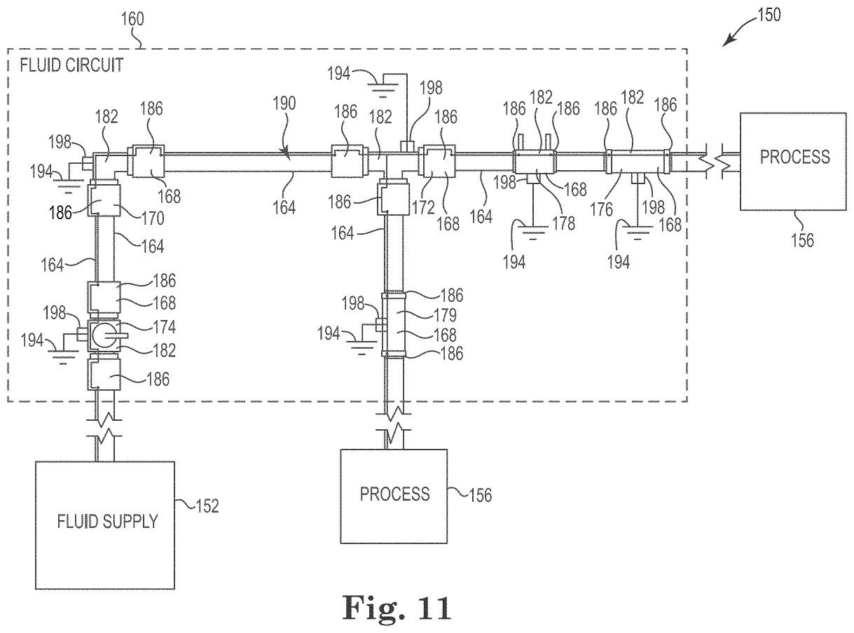

FIG. 11 illustrates a fluid circuit or fluid handling system for a predetermined fluid flow passageway is disclosed that has at least one inlet and at least one outlet. In this embodiment, fluid handling system 150 provides a flow path for fluid to flow from a fluid supply 152 to one or more process stages 156 positioned downstream of the source of fluid supply. System 150 includes a fluid circuit 160 which includes a portion of the flow path of the fluid handling system 150. The fluid circuit 160 includes tubing segments 164 and a plurality of operative components 168 that are interconnected via the tubing segments 164. In FIG. 11, the operative components 168 include an elbow shaped fitting 170, T-shaped fitting 172, a valve 174, filter 176, flow sensor 178, and straight fitting 179. However, in various embodiments the fluid circuit 160 can include additional or fewer operative components 168 in number and in type. For example, the fluid circuit 160 could substitute or additionally include pumps, mixers, dispense heads, sprayer nozzles, pressure regulators, flow controllers, or other types of operational components. In assembly, the operative components 168 are connected together by the plurality of tubing segments 164 connecting to the components 168 at their respective tubing connector fittings 186. Connected together, the plurality of tubing segments 164 and operative components 168 provide a fluid passageway through the fluid circuit 160 from the fluid supply 152 and toward the process stages 156. In certain embodiments, the operational components 168 each include a body portion 182 that defines fluid flow passageway and one or more tubing connector fittings 186. In some embodiments, at least one of the tubing connector fittings 186 is an inlet portion for receiving fluid into the body portion 182 and at least another one of the tubing connector fittings 186 is an outlet portion for outputting fluid received via the inlet portion. For example, T-shaped fitting 172 includes one tubing connector fitting 186 that is an inlet portion that receives fluid from the fluid supply 152 and two tubing connector fittings 186 which are outlet portions outputting fluid toward the process stages 156. In certain embodiments, the inlet portion and the outlet portion are each connected or connectable to a tubing segment 164. However, in some embodiments, for example where the operative components 168 in the fluid circuit 160 includes a spray nozzle, only the inlet portion is required to be connectable to a tubing segment 164. In some embodiments one or more of the operative components 168 includes a single tubing connector or fitting 179. In this embodiment each body portion 182 is additionally constructed using a conductive material to form a conductor portion that extends between and provides a conductive pathway between each of the tubing connector fittings 186. In various embodiments, the conductive pathway is bonded to and uniform with the body portion 182 and is constructed from a conductive polymeric material. For example, in some embodiments the conductor portion is constructed from PFA loaded with conductive material. This loaded PFA includes, but is not limited to, PFA loaded with carbon fiber, nickel coated graphite, carbon fiber, carbon powder, carbon nanotubes, metal particles, and steel fiber. In various embodiments, operative components in this disclosure refer to any component or device having a fluid input and a fluid output and that connect with tubing for directing or providing for the flow of fluid. Examples of operative components include, but are not limited to, fittings, valves, filters, heat exchanges, sensors, pumps, mixers, spray nozzles, and dispense heads. These and additional non-limiting examples of operative components are illustrated, for example, in U.S. Pat. Nos. 5,672,832; 5,678,435; 5,869,766; 6,412,832; 6,601,879; 6,595,240; 6,612,175; 6,652,008; 6,758,104; 6,789,781; 7,063,304; 7,308,932; 7,383,967; 8,561,855; 8,689,817; and 8,726,935, each of which are incorporated herein by reference, except for express definitions or patent claims contained in the listed documents.

The operative components may be constructed from conductive fluoropolymers including, for example, perfluoroalkoxy alkane (PFA), ethylene and tetrafluoroethylene polymer (ETFE), ethylene, tetrafluoroethylene and hexafluoropropylene polymer (EFEP), fluorinated ethylene propylene polymer (FEP), tetrafluoroethylene p[polymer PTFE), or other suitable polymeric materials. For example, in some embodiments the conductive fluoropolymers are PFA loaded with conductive material (e.g. loaded PFA). This loaded PFA includes, but is not limited to, PFA loaded with carbon fiber, nickel coated graphite, carbon fiber, carbon powder, carbon nanotubes, metal particles, and steel fiber. In various embodiments, conductive materials have a surface resistivity level less than about 1×10⁸ ohms per square while non-conductive materials have a surface resistivity level greater than about 1×10¹⁰ ohms per square. In certain embodiments, conductive materials have a surface resistivity level less than about 1×10⁹ ohms per square while non-conductive materials have a surface resistivity level greater than about 1×109 ohms per square. When the disclosed fluid handling systems are configured for use in ultra-pure fluid handling applications, both the tubing segments and operational components are typically constructed from polymeric materials to satisfy purity and corrosion resistance standards.

In various embodiments, tubing segments in this disclosure typically refer to any flexible or inflexible pipe or tube that is suitable for containing or transporting fluid. Tubing segments are conductive, providing a conductive pathway along the length of each tubing segment in the fluid circuit. Conductive tubing may be constructed from materials including metal or loaded polymeric material. Loaded polymeric material includes a polymer that is loaded with steel wire, aluminum flakes, nickel coated graphite, carbon fiber, carbon powder, carbon nanotubes, or other conductive material. In some instances, the tubing segments are partially conductive, having a main portion constructed from non-conductive or low conductive material, such as constructed from various hydrocarbon and non-hydrocarbon polymers such as, but are not limited to, polyesters, polycarbonates, polyamides, polyimides, polyurethanes, polyolefins, polystyrenes, polyesters, polycarbonates, polyketones, polyureas, polyvinyl resins, polyacrylates, polymethylacrylates and fluoropolymers. Exemplary fluoropolymers include, but are not limited to, perfluoroalkoxy alkane polymer (PFA), ethylene tetrafluoroethylene polymer (ETFE), ethylene, tetrafluoroethylene and hexafluoropropylene polymer (EFEP), fluorinated ethylene propylene polymer (FEP), and tetrafluoroethylene polymer (PTFE), or other suitable polymeric materials, and having, for example, a secondary co-extruded conductive portion. In certain embodiments the interior fluoropolymer conductive stripe of the tubing segments has a width in the range of about 0.1-1 centimeter. In selected embodiments each tubing segment has a length in a range of about 1-100 feet. In other selected embodiments, the tubing segment has an outside diameter of about ⅛ inch to about 2 inches. In other embodiments the tubing segments have a measured resistance of about 1.2×10⁴-6.7×10⁵ ohm. In still other embodiments the tubing segments have a measured resistance of about 2.5-4.3×10⁴ ohm.

In certain embodiments the interior fluoropolymer conductive stripe of the tubing segments has a width in the range of about 0.15-0.80 centimeter. In selected embodiments each tubing segment has a length in a range of about 1-500 feet (0.3-152.4 meters). In other selected embodiments, the tubing segment has an outside diameter of about ⅛ inch to about 2 inches. In other embodiments the tubing segments have a measured surface resistance of between about 2.7×10³-3.94×10⁴ ohms per square. In accordance with this disclosure, the measured surface resistance is determined using the following method:

1) Sample Preparation: Measurements are carried out on test samples prepared by injection molding, compression molding or extrusion, or directly on the final manufactured product.

2) Conditioning Procedure: Before testing, the samples are conditioned at 23° C., 50% RH for 4 hours.

3) Surface Resistance Measurement: Two parallel electrodes of silver paint are applied onto the sample using an adhesive mask. Measurements are carried out at 23° C., 50% RH. The electrical resistance (Ohm) developed between the electrodes is measured.

4) The surface resistance is calculated, taking into account the geometry of the electrode, according the following equation:

Surface resistance=R*L/g;
wherein surface resistance is ohms per square, R is the resistance of the material to the flow of charge, L is the length of the electrode (cm), and g is the distance between electrodes (cm).

Having thus described several illustrative embodiments of the present disclosure, those of skill in the art will readily appreciate that yet other embodiments may be made and used within the scope of the claims hereto attached. Numerous advantages of the disclosure covered by this document have been set forth in the foregoing description. It will be understood, however, that this disclosure is, in many respect, only illustrative. Changes may be made in details, particularly in matters of shape, size, and arrangement of parts without exceeding the scope of the disclosure. The disclosure's scope is, of course, defined in the language in which the appended claims are expressed.

What is claimed is:

1. An electrostatic discharge mitigation device comprising:
an electrically conductive insert configured to be coupled to an electrically conductive tubing segment and to an electrically conductive operative component so as to transfer static charge from the electrically conductive tubing segment to the electrically conductive operative component, the electrically conductive insert comprising a collar having a length, an inner surface, an outer surface, and a ridge circumscribing the outer surface of the collar, wherein the ridge has an outer diameter greater than an inner diameter of the electrically conductive tubing segment to which the electrically conductive insert is to be coupled so as to provide a frictional fit between the conductive insert and the electrically conductive tubing segment when the conductive insert is coupled with the electrically conductive tubing segment.

2. The electrostatic discharge mitigation device of claim 1, further comprising a plurality of ribs distributed about the outer circumference of the collar.

3. The electrostatic discharge mitigation device of claim 1, wherein the collar further defines a lip circumscribing the outer surface of the collar, the lip defining a space sized to receive and retain an end of the electrically conductive tubing segment to which the electrically conductive insert is to be coupled.

4. The electrostatic discharge mitigation device of claim 1, wherein the collar comprises a distal end including a first leading edge and a second leading edge, wherein the first leading edge is sized and shaped to be received within a recess of an electrically conductive connector and the second leading is configured to abut a proximal end of the electrically conductive connector to form a tongue-in-groove seal.

5. The electrostatic discharge mitigation device of claim 1, wherein an inner diameter of if the collar is equal to an inner diameter of an electrically conductive tubing segment to which the collar is coupled.

6. The electrostatic discharge mitigation device according to any one of claims 3-5, wherein the collar comprises an electrically conductive polymer.

7. The electrostatic discharge mitigation device of according to any one of claims 3-5 wherein the collar comprises a conductive-filled fluoropolymer.

8. The electrostatic discharge mitigation device of claim 7, wherein the conductive-filled fluoropolymer comprises perfluoroalkoxy alkane or polychlorotrifluoroethylene filled with a carbon material.

9. The electrostatic discharge mitigation device of according to claim 7, wherein the collar comprises perfluoroalkoxy alkane filled with carbon fiber.

10. A fluid circuit comprising:
an electrically conductive tubing segment;
an electrically conductive operative component; and
an electrically conductive insert coupled to the electrically conductive tubing segment and to the electrically conductive operative component so as to transfer static charge from the electrically conductive polymer segment to the electrically conductive polymer operative component,
wherein the electrically conductive insert includes a collar having a length, an inner surface, an outer surface, and a ridge circumscribing the outer surface of the collar, wherein the ridge has an outer diameter greater than an inner diameter of the electrically conductive polymer segment to which the electrically conductive insert coupled so as to provide a frictional fit between the conductive insert and the electrically conductive tubing segment, and
wherein the electrically conductive insert has a leading edge sized to be received within a recess of the electrically conductive operative component.

11. The fluid circuit of claim 10, wherein the collar further comprises a plurality of ribs distributed about the outer circumference of the collar.

12. The fluid circuit of claim 10, wherein the collar further defines a lip circumscribing the outer surface of the collar wherein an end of the electrically conductive tubing segment is received within a space defined between an inner surface of the lip and an outer surface of the collar.

13. The fluid circuit of claim 10, wherein the collar comprises a distal end including a first leading edge and a second leading edge, wherein the first leading edge is received within a recess of the electrically conductive connector and the second leading is abuts a proximal end of the electrically conductive connector to form a tongue-in-groove seal.

14. The fluid circuit of claim 10, wherein an inner diameter of the collar is equal to an inner diameter of an electrically conductive polymer segment.

15. The fluid circuit of claim 10, further comprising an electrically conductive bracket coupled to the electrically conductive connector, wherein the electrically conductive bracket includes a clamp portion and a grounding feature for connecting the electrically conductive bracket to ground.

16. The fluid circuit of any one of claims 10-14, wherein the collar comprises a conductive-filled perfluoroalkoxy alkane or polychlorotrifluoroethylene filled with a carbon material.

17. The fluid circuit of claim 16, wherein the collar comprises perfluoroalkoxy alkane filled with carbon fiber.
